(19) United States
(12) Patent Application Publication
(10) Pub. No.: US 2013/0024488 A1
(43) Pub. Date: Jan. 24, 2013

(54) SEMICONDUCTOR DEVICE

(71) Applicants: Yutaka YAMADA, Kanagawa (JP); Takashi YOSHIKAWA, Kanagawa (JP); Shigehiro ASANO, Kanagawa (JP)

(72) Inventors: Yutaka YAMADA, Kanagawa (JP); Takashi YOSHIKAWA, Kanagawa (JP); Shigehiro ASANO, Kanagawa (JP)

(21) Appl. No.: 13/627,101

(22) Filed: Sep. 26, 2012

Related U.S. Application Data
(63) Continuation of application No. PCT/JP2010/055602, filed on Mar. 29, 2010.

(51) Int. Cl. G06F 7/38

(52) U.S. Cl. 708/230

(57) ABSTRACT

According to an embodiment, a semiconductor device includes an arithmetic device that includes a first storage unit that stores first device-control information for deciding an arithmetic processing to be executed next to an arithmetic processing currently being executed by an arithmetic device and a timing at which the arithmetic processing to be executed next to the arithmetic processing currently being executed by the arithmetic device is executed; and the arithmetic device that includes a second storage unit that stores second device-control information for deciding a content of an operation contained in an arithmetic processing. The control device reads out the first device-control information, and determines whether a decision start condition defined for each arithmetic processing is satisfied by using the first device-control information, the decision start condition being a condition on which the arithmetic processing to be executed next to the arithmetic processing currently being executed is decided.

### CROSS-REFERENCE TO RELATED APPLICATION

This application is a continuation of PCT international Application Ser. No. PCT/JP2010/055602, filed on Mar. 29, 2010, which designates the United States; the entire contents of which are incorporated herein by reference.

### FIELD

Embodiments described herein relate generally to a semiconductor device.

### BACKGROUND

In order to implement sequencing without depending on a hardware configuration, Japanese Patent Application Laid-open No. 2009-187478 proposes an information processing device that selects one of a plurality of possible units of processing (unit programs) specified in advance to be executed next to a unit program currently being executed, by conditional branching control and executes the selected unit program.

Such an information processing device includes a programmable arithmetic device that executes processeings according to a program, a control device that determines a processing to be executed next, and a storage device that stores therein setting data to be supplied to the arithmetic device. A processing to be executed next to a certain processing and a condition for executing the processing are defined by a predetermined program, and information for deciding conditional branching is generated by executing a processing by the arithmetic device. Setting data to be executed next is output at a timing corresponding to a timing at which the program is switched. The control device determines a next processing according to the information for deciding conditional branching output from the arithmetic device, and outputs setting data for executing the next processing from the storage device to the arithmetic device.

With the method of Japanese Patent Application Laid-open No. 2009-187478, however, the processing to be branched to is decided and execution of the decided processing is started at the same timing. Thus, the next processing cannot be executed until the previous process is completed even in a state where the next processing is decidable, and there has been a disadvantage that it is difficult to efficiently execute parallel processing.

### BRIEF DESCRIPTION OF THE DRAWINGS

FIG. 1A is a block diagram illustrating an exemplary configuration of a semiconductor device according to an embodiment;

FIG. 1B is a block diagram illustrating an exemplary configuration of a semiconductor device including a plurality of arithmetic devices;

FIG. 2A is a block diagram illustrating an example of a configuration of a semiconductor device according to the embodiment;

FIG. 2B is a block diagram illustrating an example of a configuration of a semiconductor device according to a modified example of the embodiment;

FIG. 3A is a table illustrating an example of a data structure of first device-control information;

FIG. 3B is a table illustrating another example of the data structure of the first device-control information;

FIG. 4A is a table illustrating an example of a data structure of second device-control information;

FIG. 4B is a table illustrating an example of the data structure of the second device-control information;

FIG. 4C is a table illustrating an example of the data structure of the second device-control information;

FIG. 4D is a table illustrating an example of the data structure of the second device-control information;

FIG. 5A is a block diagram illustrating an example of more detailed configurations of a decision circuit and a start control circuit of a control device;

FIG. 5B is a block diagram illustrating an example of more detailed configurations of the decision circuit and the start control circuit of the control device;

FIG. 6A is a block diagram illustrating an example of a more detailed configuration of an arithmetic control circuit of an arithmetic device;

FIG. 6B is a block diagram illustrating an example of a more detailed configuration of the arithmetic control circuit of the arithmetic device;

FIG. 7 is a block diagram illustrating an example of a more detailed configuration of an execution circuit of the arithmetic device;

FIG. 8 is a table illustrating an example of arithmetic control information used in the configuration of FIG. 7;

FIG. 9 is a block diagram illustrating an example of a detailed configuration of the arithmetic device including an execution circuit having a configuration different from that of FIG. 7;

FIG. 10 is a table illustrating an example of a data structure of processing information stored in a processing information storage device;

FIG. 11 is table illustrating an example of a data structure of constant information stored in a constant information storage device;

FIG. 12 is a table illustrating an example of arithmetic control information used in the configuration of FIG. 9;

FIG. 13 is a block diagram illustrating an example of a detailed configuration of an arithmetic device different from those of FIGS. 7 and 9;

FIG. 14 is a table illustrating an example of arithmetic control information used in the configuration of FIG. 13;

FIG. 15 is a block diagram illustrating an example of a configuration of a semiconductor device according to a second modified example of the embodiment;

FIG. 16 is a more detailed block diagram of a control device according to the second modified example in FIG. 15;

FIG. 17 is a more detailed block diagram of an arithmetic device according to the second modified example in FIG. 15;

FIG. 18 is a flowchart illustrating a flow of the entire operation of the control device in the embodiment;

FIG. 19 is a flowchart illustrating a flow of the entire operation of the arithmetic device in the embodiment;

FIG. 20 is a diagram illustrating an example of a program to be executed;

FIG. 21 is a table representing first device-control information for executing the program of FIG. 20;

FIG. 22 is a table representing second device-control information for executing the program of FIG. 20;

FIG. 23 is a timing chart in a case where the program of FIG. 20 is processed by a conventional general-purpose processor;

FIG. 24 is a timing chart in a case where the program of FIG. 20 is processed by a semiconductor device including one arithmetic device;

FIG. 25 is a timing chart in a case where the program of FIG. 20 is processed by a semiconductor device including two arithmetic devices;

FIG. 26 is a table illustrating an example of first device-control information in a case where the program of FIG. 20 runs as illustrated in FIG. 25; and

FIG. 27 is a block diagram of an exemplary configuration of a semiconductor device in a case of allocation according to control by hardware.

### DETAILED DESCRIPTION

According to an embodiment, a semiconductor device includes an arithmetic device configured to execute a plurality of arithmetic processings containing one or more operations; and a control device configured to control the arithmetic device. The arithmetic device includes a first storage unit configured to store therein first device-control information for deciding an arithmetic processing to be executed next to an arithmetic processing currently being executed by the arithmetic device and a timing at which the arithmetic processing to be executed next to the arithmetic processing currently being executed by the arithmetic device is executed. The arithmetic device includes a second storage unit configured to store therein second device-control information for deciding a content of an operation contained in an arithmetic processing. The control device reads out the first device-control information from the first storage unit, and determines whether a decision start condition defined for each arithmetic processing is satisfied by using the first device-control information, the decision start condition being a condition on which the arithmetic processing to be executed next to the arithmetic processing currently being executed by the arithmetic device is decided. The control device decides, when the decision start condition is satisfied, the arithmetic processing to be executed next to the arithmetic processing currently being executed by the arithmetic device, by using the first device-control information, and outputs identification information for identifying the arithmetic processing to be executed next to the arithmetic processing currently being executed by the arithmetic device to the arithmetic device. The control device determines whether a processing start condition defined for each arithmetic processing is satisfied, the processing start condition being a condition on which the arithmetic processing to be executed next by the arithmetic device is executed, and instructs the arithmetic device to start the arithmetic processing when the processing start condition is satisfied. The arithmetic device reads out the second device-control information identified by the identification information from the second storage unit, decides a content of an operation contained in the arithmetic processing specified by the identification information, by using the second device-control information, and starts, when instructed to start the arithmetic processing by the control device, executing the content of the operation contained in the arithmetic processing specified by the identification information.

Preferred embodiments of a semiconductor device according to the present invention will be described below in detail with reference to the accompanying drawings.

The semiconductor device according to an embodiment includes an arithmetic device that executes a plurality of arithmetic processings including one or more instructions (operations), and a control device that controls the arithmetic processings executed by the arithmetic device. Each arithmetic processing is a unit of processing containing a plurality of operations that can be sequentially executed without occurrence of a conditional branching among operations included in a certain program, for example. A processing corresponding to a conditional branching can also be contained in a unit of processing if the processing can be executed sequentially. For example, such a processing as selecting one of a plurality of signals from a result of an operation can be executed sequentially and thus contained in a unit of processing. In the embodiment, information necessary for determination of a conditional branching is output from the arithmetic device to the control device when the information is obtained even when the information is obtained before completion of executing all the operations contained in an arithmetic processing that is a unit of processing. The control device then refers to the information to perform conditional branching control. In this manner, a branch operation (an operation of conditional branching control) by the control device and an arithmetic processing by the arithmetic device can be executed in parallel. It is thus possible to more efficiently execute processings including branching processes.

General Outline

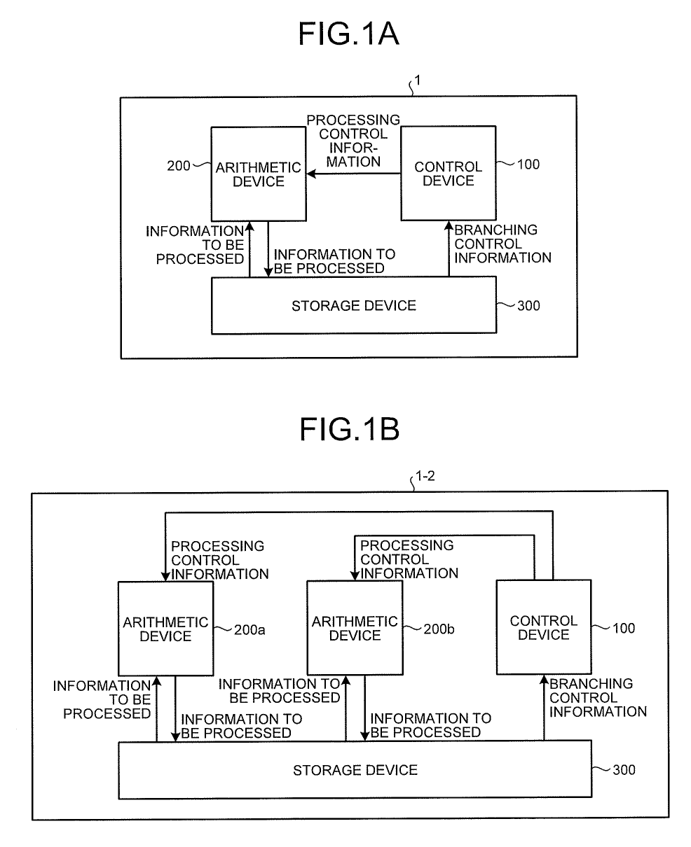

FIG. 1A is a block diagram illustrating an exemplary configuration of a semiconductor device 1 according to the embodiment. As illustrated in FIG. 1A, the semiconductor device 1 according to the embodiment includes a control device 100, an arithmetic device 200 and a storage device 300.

The control device 100 controls start of processing. The arithmetic device 200 executes an arithmetic processing instructed by the control device 100 on information stored in the storage device 300. The storage device 300 stores therein various information to be referred to by the control device 100 and the arithmetic device 200. The semiconductor device 1 operates in synchronization with an external clock signal.

Arithmetic Processing Control

The control device 100 receives branching control information that is information to be used for conditional branching control as input from the storage device 300, decides an arithmetic processing to be executed by the arithmetic device 200 and a condition under which the arithmetic processing can be started, and outputs processing control information containing identification information for uniquely identifying the arithmetic processing to be executed to the arithmetic device 200.

The identification information may be in any form as long as an arithmetic processing to be executed by the arithmetic device 200 can be identified. For example, an integer of 0 or larger (a natural number) may be assigned to each arithmetic processing and used as the identification information. Alternatively, identification information including a numerical value and a character string may be used. Still alternatively, for example, the identification information may be an address pointer of a memory storing an instruction to be executed during an arithmetic processing or may be an identifier corresponding one-to-one to an address pointer of a memory. Still alternatively, the identification information may be information including one or more instructions in a more specific manner.

The arithmetic device 200 receives processing control information as input from the control device 100, receives information to be processed that is information to be subjected to an arithmetic processing as input from the storage device 300, executes the arithmetic processing identified by identification information contained in the processing control information according to the processing control information and outputs the processing result to the storage device 300.

Although only one arithmetic device 200 is illustrated in FIG. 1A, the semiconductor device 1 may include a plurality of arithmetic devices 200. FIG. 1B is a block diagram illustrating an exemplary configuration of a semiconductor device 1-2 including a plurality of arithmetic devices 200a and 200b. The arithmetic device 200 may include a storage device other than the storage device 300. For example, the arithmetic device 200 may include an external storage device such as an external system memory, or a dedicated storage device such as a local memory for each arithmetic device 200 only. When the arithmetic device 200 includes a storage device other than the storage device 300, information to be processed does not have to be input to and output from the storage device 300.

The arithmetic device 200 may be in any form as long as the unit executes an arithmetic processing identified by identification information contained in processing control information. For example, the arithmetic device 200 may be a reconfigurable circuit that executes a processing indicated by configuration information or may be a processor that executes a processing indicated by a program. Note that an arithmetic processing to be executed by the arithmetic device 200 is uniquely defined by identification information contained in processing control information input from the control device 100. For example, it is assumed that the same arithmetic processing is executed when the same processing control information is input, the normal functions of a processor such as conditional branching are not supported and arithmetic processings to be executed are not affected by input information or internal states. Since the operation time and the operation timing of the arithmetic device 200 for each arithmetic processing can be uniquely decided on the basis of this assumption, scheduling of arithmetic processings is facilitated. In particular, when the semiconductor device 1 includes a plurality of arithmetic devices 200, control of synchronization of data sharing, data transfer and the like among the arithmetic devices 200 is facilitated.

The storage device 300 stores therein information to be processed on which the arithmetic device 200 executes an arithmetic processing and branching control information used for conditional branching control by the control device 100. The storage device 300 has a structure that can share information to be processed with one or more arithmetic devices 200 and the control device 100. For example, a multi-port memory may be used as the storage device 300. Alternatively, a dedicated memory may be provided for each of the arithmetic devices 200 and the control device 100, and a control device for sharing information to be processed may be additionally provided.

Timing Control

The control device 100 performs control according to first device-control information that is set in advance for controlling the operation of the control device 100. The first device-control information contains a condition on which an arithmetic processing can be started (processing start condition), a condition on which decision of a next arithmetic processing (herein after referred to as a next processing) of an arithmetic processing can be started (decision start condition), a condition on which a next processing is decided (decision condition), and information indicating a next processing for each determination result under the decision condition (next processing candidate information). Details of the first device-control information will be described later.

The control device 100 determines a timing for deciding a next processing according to the decision start condition and information (first completion information, details of which will be described later) input from the arithmetic device 200 or the storage device 300. When the decision start condition is satisfied, the control device 100 determines the decision condition by using branching control information input from the storage device 300. The control device 100 then generates identification information of the next processing determined according to the decision condition, and outputs the identification information to the arithmetic device 200 at an appropriate timing.

After determining the conditions, the control device 100 determines the processing start condition corresponding to the identification information of the decided next processing, generates start control information representing whether or not to start execution of the operation, and outputs the start control information to the arithmetic device 200. The control device 100 first determines the timing for starting the arithmetic processing indicated by the identification information according to the processing start condition and information (second completion information, details of which will be described later) input from the arithmetic device 200. If the processing start condition is satisfied, the control device 100 generates start control information indicating that the processing can be started and outputs the start control information to the arithmetic device 200. If the processing start condition is not satisfied, the control device 100 generates start control information indicating that the processing cannot be started and outputs the start control information to the arithmetic device 200.

After completion of the process (hereinafter referred to as a decision process) of deciding the next processing, the control device 100 further executes a decision process for deciding an arithmetic processing to be executed next to the next processing. The decision process for deciding the arithmetic processing to be executed next to the next processing can be executed similarly by using the first device-control information for the arithmetic processing indicated by the identification information. The timing for executing the decision process may be after generating the identification information or may be after generating the identification information, further satisfying the processing start condition and generating the start control information indicating that the processing can be executed.

The arithmetic device 200 executes an arithmetic processing indicated by identification information input from the control device 100. The timing for starting the arithmetic processing is controlled by the start control information. If executing the next processing is not permitted by the start control information even when the next processing is decided, the decided next processing cannot be executed. It is, however, possible to perform necessary preparation for executing the next processing. For example, in a case of a reconfigurable circuit, configuration information for an arithmetic processing indicated by the identification information may be set in advance in the arithmetic device 200. As a result, the overhead relating to settings at starting of an arithmetic processing can be reduced. Alternatively, in a case of the arithmetic device 200 including a cache, setting information necessary for an arithmetic processing may be prefetched in the cache in advance. As a result, it is possible to avoid cache miss during execution and improvement in the performance can be expected. In this manner, the overall performance can be improved by preparing for a next processing before starting execution thereof.

In addition, a storage device (not illustrated) for storing therein identification information and start control information may be provided between the control device 100 and the arithmetic device 200 or inside of at least one of the control device 100 and the arithmetic device 200. With such a configuration, the control device 100 can generate a plurality of pieces of processing control information for a plurality of arithmetic processings to be executed afterwards in addition to that for one arithmetic processing to be executed next. Moreover, since the arithmetic processings to be executed afterward are defined, the arithmetic device 200 can efficiently prepare for the arithmetic processings. In particular, in a case of a configuration including a plurality of arithmetic devices 200, it is possible to increase the efficiency of control by assigning the same arithmetic processing or similar arithmetic processings to one arithmetic device 200.

Outline of Device Configuration

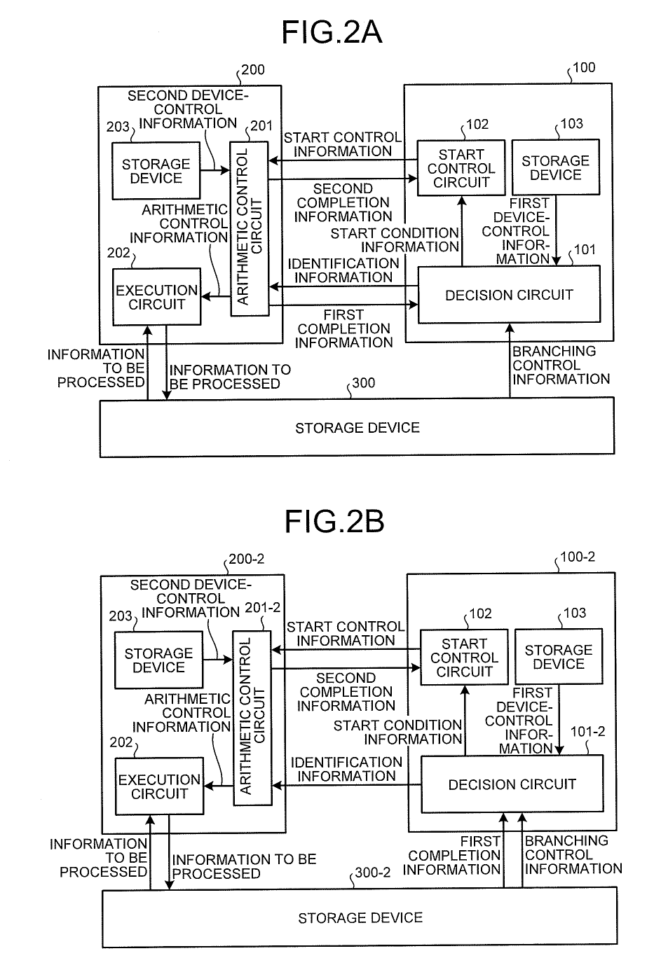

FIG. 2A is a block diagram illustrating an example of a configuration of the semiconductor device 1 according to the embodiment. First, functions of components of the control device 100 will be described. As illustrated in FIG. 2A, the control device 100 includes a decision circuit 101 that decides a next processing, a start control circuit 102 that controls a timing at which the arithmetic device 200 starts an arithmetic processing, and a storage device 103 that stores therein first device-control information.

The decision circuit 101 receives first completion information as input from the arithmetic device 200, receives branching control information as input from the storage device 300, and receives first device-control information as input from the storage device 103. The first completion information is information indicating that the arithmetic device 200 has completed execution of a specific operation contained in a specific arithmetic processing. In the embodiment, information indicating that execution of a predetermined operation of outputting information necessary for conditional branching control is completed is used as the first completion information.

For example, the first completion information may be an interrupt signal indicating that information necessary for deciding an arithmetic processing is written into the storage device 300 or may be an interrupt signal informing that a specific operation among respective instructions (operations) contained in an arithmetic processing is completed. Alternatively, the first completion information may be address information for writing information into the storage device 300.

The first completion information may be input from the storage device 300 instead of being input from the arithmetic device 200. FIG. 2B is a block diagram illustrating an example of such a configuration of the semiconductor device 1 according to a first modified example of the embodiment. In this modified example, the configuration is different from that of FIG. 2A in that an arithmetic control circuit 201-2 saves first completion information in a storage device 300-2 and that a decision circuit 101-2 receives the first completion information as input from the storage device 300-2. Since the other components are similar to those in FIG. 2A, the components will be designated by the same reference numerals and the description thereof will not be repeated. In particular, for informing of written address information, control can be simplified by inputting the first completion information from the storage device 300 as in this modified example.

Referring back to FIG. 2A, the decision circuit 101 generates start condition information containing identification information and a processing start condition of a next processing from a decision start condition, a decision condition and the processing start condition contained in first device-control information and branching control information. The decision circuit 101 then outputs the identification information to the arithmetic device 200 and the start condition information to the start control circuit 102.

The processing start condition contained in the start condition information is a condition for determining whether to start execution of an arithmetic processing. For example, the processing start condition represents a condition for determining whether a specific interrupt signal or information is input from the arithmetic device 200 or the storage device 300. Since an arithmetic processing to be executed by the arithmetic device 200 is uniquely defined by the identification information, the number of cycles of the entire arithmetic processing or the number of cycles until specific information is generated can also be determined for each piece of identification information. The processing start condition may therefore represent a condition for determining whether a waiting time (the number of cycles) until a specified arithmetic processing is started.

The decision circuit 101 executes a decision process for deciding a next processing according to a decision condition if the decision start condition is satisfied, or does not execute a decision process if the decision start condition is not satisfied. The decision circuit 101 performs determination on the basis of whether or not the first completion information satisfies the decision start condition. For example, when the decision start condition is an input of an interrupt flag, the decision circuit 101 executes the decision process when a corresponding interrupt flag is input from the arithmetic device 200. The decision circuit 101 decides a next processing according to a decision condition in the decision process. When the next processing is decided, the decision circuit 101 generates start condition information containing a processing start condition for the next processing, and outputs the start condition information to the start control circuit 102. The decision circuit 101 also reads out first device-control information for the decided next processing from the storage device 103, and further executes the decision process for a process to be executed next to the next processing.

The start control circuit 102 receives start condition information as input from the decision circuit 101 and receives second completion information as input from the arithmetic device 200. The second completion information is information indicating that the arithmetic device 200 has completed execution of a specific operation contained in a specific arithmetic processing similarly to the first completion information. In the embodiment, information indicating that execution of a predetermined operation of outputting information necessary for another arithmetic processing is completed is used as the second completion information. In other words, the second completion information is information to be used for synchronization of an arithmetic processing with another arithmetic processing in which the output result of the arithmetic processing is used.

The start control circuit 102 determines whether or not execution of the arithmetic processing can be started on the basis of the start condition information and the second completion information, and outputs start control information representing the determination result. For example, the start control circuit 102 changes the internal state thereof according to the second completion information, and generates start control information indicating that the arithmetic processing can be started if the internal state satisfies the processing start condition contained in the start condition information. If the internal state does not satisfy the processing start condition, on the other hand, the start control circuit 102 generates start control information indicating that the arithmetic processing cannot be started. The start control circuit 102 then outputs the generated start control information to the arithmetic device 200.

The method for determining whether or not an arithmetic processing can be started used by the start control circuit 102 is not limited to the above but any method can be used depending on the processing start condition contained in the start condition information. For example, when the processing start condition represents a condition for determining whether a predetermined number of cycles has been gone through, the start control circuit 102 may output start control information indicating that an arithmetic processing is permitted to be started at a time when a counter value of the number of cycles reaches a predetermined value. When the processing start condition represents a condition of waiting until a specific interrupt signal is input from the arithmetic device 200 or the storage device 300, the start control circuit 102 may output start control information indicating that an arithmetic processing is permitted to be started at a time when the interrupt signal is input.

The storage device 103 stores therein first device-control information. Upon receiving a request from the decision circuit 101, the storage device 103 outputs the first device-control information to the decision circuit 101.

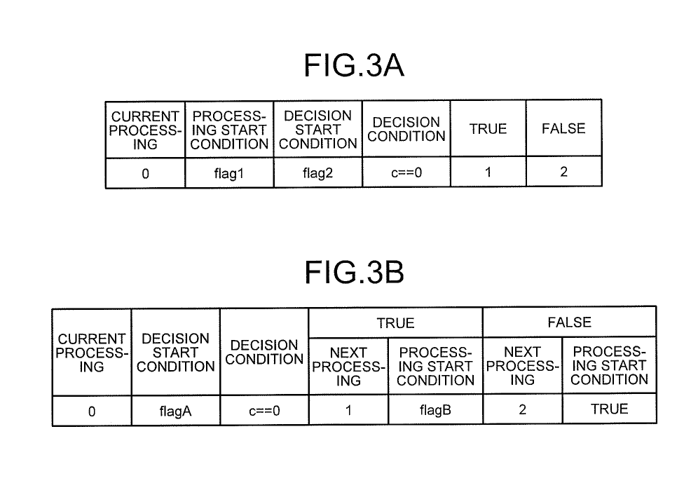

Details of the first device-control information will be described here. The first device-control information may be in any form as long as the control device 100 can determines a next processing and a timing at which the next processing is to be executed for the arithmetic processing currently being executed. FIG. 3A is a table illustrating an example of a data structure of the first device-control information.

As illustrated in FIG. 3A, the first device-control information contains a processing start condition, a decision start condition, a decision condition and next processing candidate information of an arithmetic processing currently being executed (current processing). FIG. 3A illustrates an example in which identification information (1) of an arithmetic processing when the determination result according to the decision condition is true and identification information (2) of an arithmetic processing when the determination result is false are set as next processing candidate information.

The first device-control information may contain other information relating to process control. For example, the first device-control information may contain a condition for deciding a next processing from the candidates. Although not illustrated in FIG. 3A, the storage device 103 stores first device-control information including information indicating that all arithmetic processings have been completed. For example, the information indicating that all arithmetic processings have been completed is set as next processing candidate information for an arithmetic processing to be executed last.

Although the current processing and the next processing are each represented by the identification information in the example of FIG. 3A, the content of an arithmetic processing itself may be described instead. Alternatively, an address pointer of a storage device 203 that stores therein the content of an arithmetic processing may be described. When the identification information is used, reading of first device-control information is facilitated by storing the first device-control information in a memory. When an address pointer is used, conversion to an arithmetic processing in the arithmetic device 200 is facilitated.

In the example of FIG. 3A, a condition representing an input of a specific flag such as “flag1” is presented as the processing start condition and the decision start condition. The method for specifying each condition is not limited thereto and may be in any form as long as a condition for starting an arithmetic processing or a decision process can be presented. For example, the conditions may be specified as a specific number of cycles to be waited such as “waiting for three cycles” or may be specified as a condition under which specific information is within a specific range such as “c==0”. The specific information may be information (first completion information, second completion information) input from the arithmetic device 200, or may be information stored in the storage device 300.

Conditions under which two determination results of true/false such as “c==0” are obtained are specified in the example of FIG. 3A but conditions that can be applied are not limited thereto. For example, comparison among a plurality of conditions such as determination between two results by determining whether (a<b) && (c<d) is true or false and determination among four results combining a result of (a<b) and a result of (c<d) may be used. Alternatively, conditions under which three or more determination results are obtained may be used. In this case, next processings for the respective determination results, the number of next processings corresponding to the number of determination results, have to be prepared. For example, in a case of conditions such as “x & 0x7”, the number of next processings to be prepared for the respective determination results is eight. When such conditions are used, more flexible conditional determination can be made. When such conditions as waiting for an input of a specific flag as in the example of FIG. 3A are used, the determination circuit can be simplified and the determining process can be executed at a higher speed.

Details of the branching control information stored in the storage device 300 will be described here. The branching control information can have various structures depending on the methods for specifying the decision conditions. In a case of decision conditions using operations such as “C==0” and “X<0”, addresses specified as addresses where variables (C, X, etc.) used in the operations or the variables can be used as the branching control information, for example. In a case of decision conditions that determines whether a specific flag such as “flagA” is present or not, a signal representing the flag such as one or more interrupt signals may be used as the branching control information instead of the information itself. Alternatively, information representing the presence or the absence of a flag may be stored at a specific address of the storage device 300 and the control device 100 may perform conditional branching by determining the value of the address (non-zero determination, for example).

When a process to be executed is always defined uniquely and it is not necessary to perform determination, the processing start condition, the decision start condition and the decision condition may be expressed by using either of true and false. For example, “true” may be registered as a processing start condition when an arithmetic processing is always executable and “false” may be registered as a processing start condition when an arithmetic processing is always non-executable. In addition, “true” may be registered as a decision start condition when a decision process is always executable and “false” may be registered as a decision start condition when a decision process is always non-executable. In addition, when a next processing is always defined to one arithmetic processing, the decision condition may be set to “true” and the arithmetic processing may be registered as a determination result representing “true”, the arithmetic processing may be registered as all the determination results.

Although the methods for indicating that a uniquely defined process is to be executed are not limited to those described above, such methods as described above allow the indication by using the same format whether the conditional determination is present or not, which can simplify the circuits that analyze the formats.

FIG. 3B is a table illustrating another example of the data structure of the first device-control information. The structure of the first device-control information of FIG. 3B is different from that of FIG. 3A only in the processing start condition. In the first device-control information of FIG. 3B, a processing start condition for a next processing is registered as the processing start condition instead of the processing start condition for the current processing. As a result, the amount of information is increased because the processing start condition needs to be presented for each candidate of the next processing but the control is facilitated when the processing start condition varies depending on the relations between previous and next arithmetic processings. Moreover, this can also contribute to simplification of control in that the processing start condition is decided before reading new first device-control information after a next processing is decided.

Referring back to FIG. 2A, functions of the respective components of the arithmetic device 200 will be described next. As illustrated in FIG. 2A, the arithmetic device 200 includes an arithmetic control circuit 201 that controls execution of arithmetic processings according to identification information and start control information input from the control device 100, an execution circuit 202 that executes an arithmetic processing on information to be processed input from the storage device 300, and the storage device 203 that stores therein information necessary for the arithmetic processings.

The storage device 203 outputs the second device-control information for an arithmetic processing represented by the identification information to the arithmetic control circuit 201 in response to a request from the arithmetic control circuit 201. The storage device 203 receives the second device-control information necessary for an arithmetic processing as input in advance before the arithmetic processing is started. The second device-control information may be externally input to the storage device 203 during execution of an arithmetic processing. When the identification information has a structure containing one or more instructions, the storage device 203 may not be provided.

The arithmetic control circuit 201 receives the identification information and the start control information as input from the control device 100, and controls the arithmetic processing represented by the identification information to be executed at a timing indicated by the start control information. The arithmetic control circuit 201 also generates arithmetic control information for controlling execution of operations contained in the arithmetic processing and outputs the arithmetic control information to the execution circuit 202.

The arithmetic control circuit 201 reads out the second device-control information for the input identification information from the storage device 203. The second device-control information is information defining contents of operations and the like contained in the arithmetic processing identified by the identification information. When the identification information has a structure including one or more instructions, the second device-control information need not be read out from the storage device 203 because instructions to be executed are contained in the identification information.

When the identification information indicates an address in the storage device 203, the arithmetic control circuit 201 reads out the second device-control information at the address. The arithmetic control circuit 201 outputs the arithmetic control information generated from the read second device-control information to the execution circuit 202. The arithmetic control circuit 201 then reads out next second device-control information at an address in the storage device 203 where the next second device-control information is stored. The address of the next second device-control information specifies a next address of the address specified as the identification information, for example. The second device-control information may contain therein information capable of specifying the address of next second device-control information. The above-described process is repeated until second device-control information containing information indicating completion of operations is read.

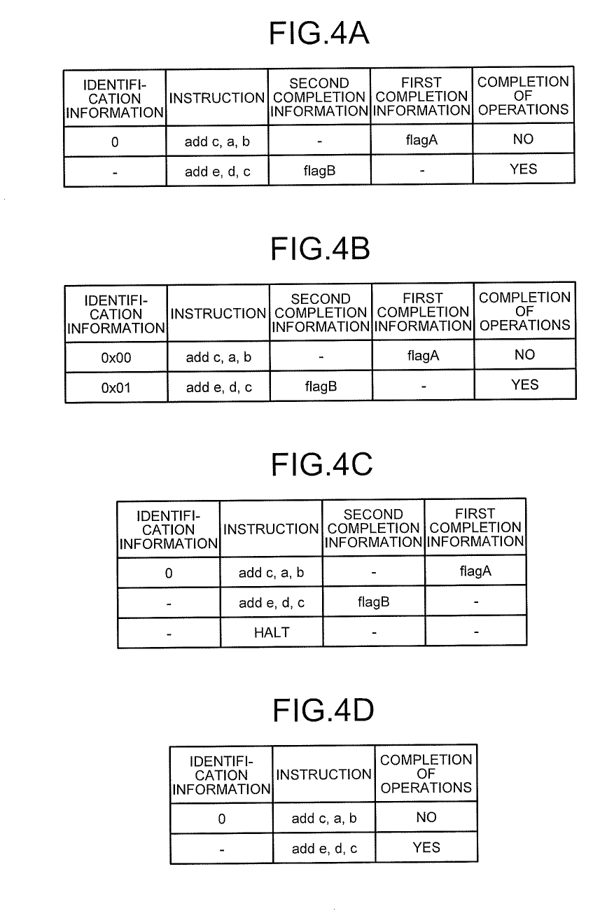

FIGS. 4A to 4D are tables illustrating examples of the data structure of the second device-control information held in the storage device 203. In the example of FIG. 4A, the second device-control information contains identification information of an arithmetic processing, instructions to be executed by the execution circuit 202, second completion information used for determination of the processing start condition, first completion information used for determination of determination start condition, and information representing whether or not all the operations contained in the arithmetic processing are completed (completion of operations).

Each line of the second device-control information corresponds to one operation contained in one arithmetic processing. When one arithmetic processing contains a plurality of operations, the operations are stated in the descending order of execution from the top. FIG. 4A illustrates an example in which “−” is set as identification information of second and subsequent operations to be executed. The completion of operations is set to “Yes” for an operation with no subsequent operations to be executed among operations contained in one arithmetic processing. When a subsequent operation to be executed is present, “No” is set to the completion of operations.

For sequentially executing an arithmetic processing identified by the identification information contained in processing control information input from the control device 100, the arithmetic device 200 executes instructions in the order from an instruction with identification information corresponding to the identification information to a closest instruction indicating completion of operations.

FIG. 4A illustrates an example in which a numerical value is used as the identification information. As described above, an address pointer may be used as the identification information. FIG. 4B illustrates an example of the data structure of the second device-control information when an address pointer is used as the identification information.

When a numerical value is used as the identification information, an arithmetic processing can be specified with a small amount of information. When an address pointer is used, on the other hand, more flexible specification such as starting from an operation in a specific arithmetic processing is possible.

Instructions (operations) vary greatly depending on the configuration of the arithmetic device 200. Although arithmetic operations are presented as instructions in the examples of FIG. 4A, etc., instructions such as load/store may be registered when the arithmetic device 200 is a controller of an external memory. Alternatively, identifiers such as configuration IDs may be used instead of instructions when the arithmetic device 200 is a circuit requiring complex instructions such as a dynamically reconfigurable circuit.

The second completion information and the first completion information represent flags to be output to the control device 100, but may be in any form as long as the second completion information and the first completion information are each information that can be used for determination under the processing start condition or the decision start condition. For example, a specific value may be specified or a combination of a specific address and a specific value may be specified instead of a flag. When the second completion information and the first completion information have the same structure (when the second completion information and the first completion information are represented by flags as in FIGS. 4A and 4B, for example), these need not be distinguished within the second device-control information. For example, the second device-control information may contain one piece of “completion information”. In this case, the arithmetic control circuit 201 sends “completion information” without distinguishing between the first completion information and the second completion information, and the decision circuit 101 and the start control circuit 102 in the control device 100 each used the received “completion information” to determine a condition.

Information indicating whether or not all operations contained in an arithmetic processing are completed is not limited to the information (completion of operations) as in FIGS. 4A and 4B. For example, the number of instructions to be executed may be added to a first operation of an arithmetic processing identified by the identification information. In this case, the arithmetic control circuit 201 determines that all operations are completed when operations corresponding to the number of instructions to be executed have been executed. Alternatively, an instruction indicating completion of a process such as “HALT” may be registered in the field of instruction as in FIG. 4C.

FIGS. 4A to 4C illustrate exemplary configurations of the second device-control information in a case where timing control by means of a control signal (start control information) from the control device 100 is executed. When timing control is executed statically inside the control device 100, the first completion information and the second completion information are not needed, and the second device-control information may thus contain identification information, an instruction, and completion of operations as illustrated in FIG. 4D.

Referring back to FIG. 2A, the arithmetic control circuit 201 waits until a specified arithmetic processing becomes in a state where execution thereof can be started according to start control information input from the control device 100, generates arithmetic control information from the second device-control information when the arithmetic processing becomes in the state where execution thereof can be started, and outputs the generated arithmetic control information to the execution circuit 202. The arithmetic control information contains instructions on lines of the second device-control information as in FIG. 4A.

For sequentially executing operations, the arithmetic control circuit 201 continuously reads out the second device-control information in a state where processings can be executed, and outputs arithmetic control information containing instructions defined in the read second device-control information to the execution circuit 202. When the read second device-control information contains information indicating completion of operations (such as completion of operations=“Yes”), the arithmetic processing is completed and the state changes into a process execution halted state.

In addition to outputting the arithmetic control information to the execution circuit 202, the arithmetic control circuit 201 generates second completion information for controlling an arithmetic processing executable state of the arithmetic device 200 or another arithmetic devices 200 and first completion information for controlling whether or not to start a decision process for determining a next processing in the arithmetic device 200 or another arithmetic device 200, and outputs the generated second completion information and first completion information to the control device 100. When the first completion information is input to the control device 100 from the storage device 300 as illustrated in FIG. 2B, the arithmetic control circuit 201 outputs only second completion information to the control device 100.

The execution circuit 202 receives arithmetic control information as input from the arithmetic control circuit 201, receives information to be processed as input from the storage device 300, executes operations indicated by the arithmetic control information on the information to be processed, and outputs the result the operations to the storage device 300.

When the arithmetic control information is input from the arithmetic control circuit 201, the execution circuit 202 identifies information to be processed, operations to be executed, the destination to save the operation result, etc. from the arithmetic control information. The execution circuit 202 then reads out the identified information to be processed from the storage device 300, executes the identified operations and stores the operations result to the identified destination to save. The source from which the information to be processed is read out or the destination where the processed information is written is not only the storage device 300, but a system memory outside of the semiconductor device 1 or another storage device inside of the semiconductor device 1 may be specified therefor or a local memory inside of the arithmetic device 200 may be specified therefor.

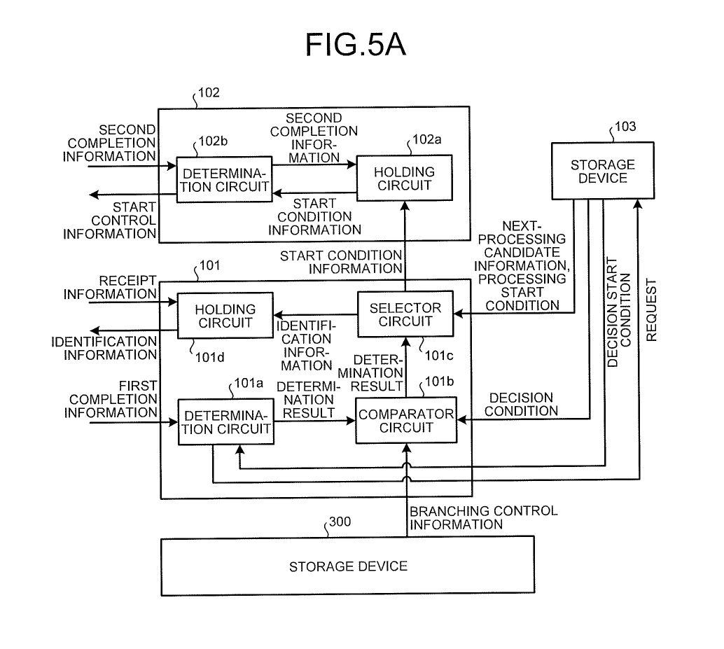

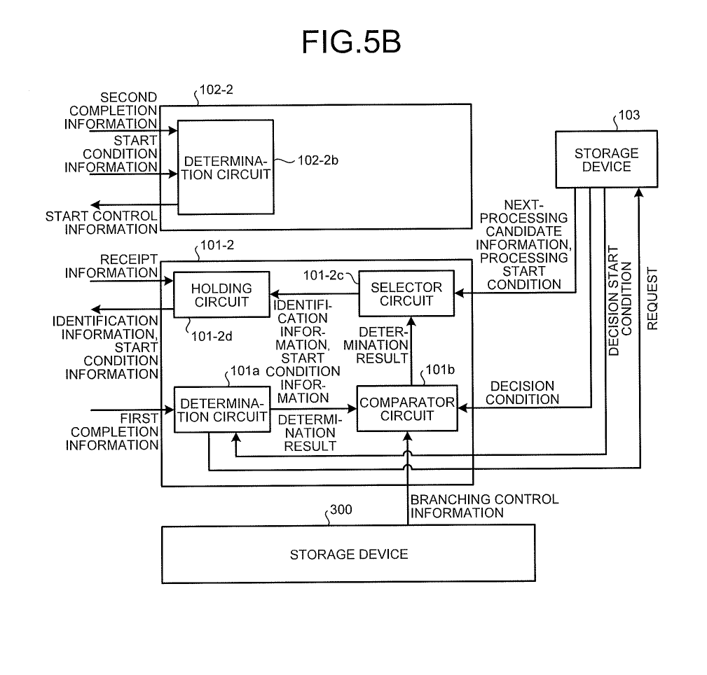

Next, more detailed configurations of the components of the control device 100 will be described. FIG. 5A is a block diagram illustrating an example of more detailed configurations of the decision circuit 101 and the start control circuit 102 of the control device 100. First, a detailed configuration of the decision circuit 101 will be described. As illustrated in FIG. 5A, the decision circuit 101 includes a determination circuit 101a, a comparator circuit 101b, a selector circuit 101c and a holding circuit 101d.

The determination circuit 101a is a circuit that determines a timing at which a next processing is determined. The determination circuit 101a determines whether or not the internal state, information (first completion information or second completion information) input from the arithmetic device 200 or the storage device 300, etc. satisfy a decision start condition input from the storage device 103. The determination circuit 101a outputs the determination result to the comparator circuit 101b. For example, the determination circuit 101a outputs a determination result indicating “valid (true)” when the decision start condition is satisfied or outputs a determination result indicating “invalid (false)” when the decision start condition is not satisfied. The determination circuit 101a also outputs request information requesting first device-control information of an arithmetic processing corresponding to the next processing to the storage device 103.

The determination process executed by the determination circuit 101a is not particularly limited as long as it is possible to determine whether or not a decision start condition is satisfied. For example, when a decision start condition indicates only the number of cycles to wait for, the determination circuit 101a may output a determination result=“valid” at a time point when the counter of the number of cycles reaches a predetermined value.

Such a configuration can be said to be a configuration in which a timing at which a next processing is decided is indicated by the decision start condition. For example, when the arithmetic device 200 does not have a conditional branching mechanism or the like and operates sequentially and statically, the timing at which a process is to be executed is decided statically. In such a case, it is possible to perform timing control with a configuration in which only the number of cycles to wait for is specified in the decision start condition. With such a configuration, the structure of the control device 100 can be made simpler.

In a case where the decision start condition is a condition of waiting until an input of a specific control signal is input from the arithmetic device 200, the storage device 300 or inside of the control device 100, the determination circuit 101a may be configured to determine the control signal. For example, the determination circuit 101a may determine the decision start condition on the basis of first completion information input from the arithmetic device 200 or the storage device 300.

With such a configuration, more flexible timing control can be realized as compared to a case of waiting for a fixed number of cycles. Even when the timing at which the first completion information is input varies, the size of control information can be reduced since the same control information can be used for the timing control. The determination circuit 101a outputs request information requesting first device-control information for a next processing to the storage device 103 after the next processing is decided.

The comparator circuit 101b receives a determination result obtained by the determination circuit 101a as input from the determination circuit 101a, receives a decision condition as input from the storage device 103, and receives branching control information as input from the storage device 300. When the determination result obtained by the determination circuit 101a indicates validity, the comparator circuit 101b determines whether the branching control information satisfies the decision condition, and outputs the determination result to the selector circuit 101c. When the determination result obtained by the determination circuit 101a indicates invalidity, the comparator circuit 101b outputs the determination result indicating false to the selector circuit 101c.

The structure of the determination result output by the comparator circuit 101b is defined by the number of candidates of next processing candidate information contained in the first device-control information. When the number of pieces of next processing candidate information is one, information indicating which to select from the candidates of a next processing is not needed, and information indicating that the condition is satisfied alone is sufficient. When the number candidates in the next processing candidate information is two, information on the basis of which one candidate can be selected from the two (information such as true and false, for example) may be contained in the determination result in addition to the information indicating that the condition is satisfied. When the number of candidates in the next processing candidate information is three or more, information on the basis of which an appropriate candidate can be selected may be contained in the determination result.

The comparator circuit 101b may have any configuration as long as the comparator circuit 101b is a circuit that can execute a process indicated by a decision condition. For example, in a case where the decision condition is a condition for determination based on the presence or the absence of input branching control information alone, the comparator circuit 101b may be configured as a circuit that determines whether the branching control information is true or false. Alternatively, when the decision condition is a condition for determining a range of the result of a numerical calculation such as a program expression (“c==0”, for example) of a programming language such as C language, the comparator circuit 101b may have a configuration capable of executing operations such as comparison operations, logical operation and four arithmetic operations.

The selector circuit 101c receives next processing candidate information and a processing start condition as input from the storage device 103, and receives the determination result obtained by the comparator circuit 101b as input from the comparator circuit 101b. The selector circuit 101c selects a next processing indicated by the determination result obtained by the comparator circuit 101b from candidates of the next processing contained in the next processing candidate information. The selector circuit 101c selects a processing start condition for the identification information of the next processing and generates start condition information containing the identification information of the next processing and the selected processing start condition. The selector circuit 101c outputs the identification information of the next processing to the holding circuit 101d and outputs the start condition information to the start control circuit 102.

The generation of the start condition information may vary depending on the data structure of the first device-control information. When the first device-control information contains the processing start condition for an arithmetic processing currently being executed (the example of FIG. 4A), a configuration with which a processing start condition for a next processing is read and output after the next processing is decided may be used. Alternatively, when a structure in which the processing start condition of a next processing is added to the next processing candidate information is used (the example of FIG. 4B), the processing start condition may be selected together with the next processing candidate information.

The holding circuit 101d is a circuit that holds identification information input from the selector circuit 101c and outputs the identification information to the arithmetic device 200. The holding circuit 101d may have a configuration that holds only one piece of identification information or may have a configuration that holds a plurality of pieces of identification information. The configuration that holds a plurality of pieces of identification information may be any configuration as long as the order in which the pieces of identification information are input is maintained. For example, the configuration may be realized by a general storage device and a control circuit or by a first-in, first-out storage device such as a FIFO memory.

When receipt information indicating that the identification information is received is input from the arithmetic device 200, the holding circuit 101d determines that the identification information is received by the arithmetic device 200, and terminates the output of the identification information to the arithmetic device 200. In a case of the configuration that holds only one piece of identification information, the holding circuit 101d does not update the identification information held therein while the holding circuit 101d holds the identification information even when new identification information is input from the selector circuit 101c, and holds the new identification information therein after the identification information is received by the arithmetic device 200.

In a case of the configuration capable of holding a plurality of pieces of identification information, the holding circuit 101d can hold new identification information if there is an available storage area therein when the new identification information is input from the selector circuit 101c while the holding circuit 101d holds pieces of identification information therein. If there is no available storage area therein, the holding circuit 101d waits until the identification information is received by the arithmetic device 200 similarly to the configuration that can hold only one piece of identification information. When receipt information is input from the arithmetic device 200 during a state in which the holding circuit 101d holds two or more pieces of identification information in storage areas therein, the holding circuit 101d discards the identification information being output from the storage area therein and outputs identification information that is input next to the arithmetic device 200.

Next, a detailed configuration of the start control circuit 102 will be described. As illustrated in FIG. 5A, the start control circuit 102 includes a holding circuit 102a and a determination circuit 102b.

When start condition information is input from the decision circuit 101, the holding circuit 102a holds the start condition information therein and outputs corresponding start condition information to the determination circuit 102b. When second completion information is input from the determination circuit 102b, the holding circuit 102a determines that the start condition information is received and terminates the output of the start condition information. The holding circuit 102a may have a configuration capable of holding only one piece of start condition information or may have a configuration holding a plurality of pieces of start condition information, where the number of pieces of start condition information held by the holding circuit 101d needs to be equal to the number of pieces of identification information held thereby. When a plurality of pieces of identification information are held, the order in which the pieces of identification information are input needs to be maintained similarly to the holding circuit 101d.

The determination circuit 102b determines whether or not a next processing can be executed on the basis of the start condition information input from the holding circuit 102a and second completion information input from the arithmetic device 200, and outputs start control information that is a determination result to the arithmetic device 200. The determination circuit 102b may have any configuration as long as the determination circuit 102b can execute a processing indicated by a processing start condition contained in the start condition information. For example, when a processing start condition indicates the number of cycles to wait for, the determination circuit 102b may be configured to count the number of cycles by means of a counter or the like and compare the number of cycles to wait for and the current number of counts. In this case, the second completion information from the arithmetic device 200 is not necessary, which can simplify the control. In a case where the processing start condition is a condition of waiting until a specific interrupt signal is input from the arithmetic device 200, the storage device 300 or the control device 100, the determination circuit 102b has a configuration capable of determining input of a specified interrupt signal. In this case, more flexible control can be executed as compared to a case where a fixed number of cycles are waited for. In a case where the processing start condition is a condition of waiting until specific information stored in the storage device 300 becomes a specific value, the determination circuit 102b may be configured to support processes such as access to the storage device 300, four arithmetic operations and logical operations.

Next, another exemplary configuration of the components of the control device 100 will be described. FIG. 5B is a block diagram illustrating an example of more detailed configurations of a decision circuit 101-2 and a start control circuit 102-2 according to another exemplary configuration.

FIG. 5B illustrates an exemplary configuration in a case where start condition information is stored in the arithmetic device 200 instead of the control device 100 (holding circuit 102a). As illustrated in FIG. 5B, the start condition information is output to the arithmetic device 200 from a selector circuit 101-2c passing through a holding circuit 101-2d together with the identification information. A determination circuit 102-2b receives the start condition information as input from the arithmetic device 200 and executes a determination process similarly to the case where the start condition information is input from the holding circuit 102a of FIG. 5A. The determination circuit 102-2b then outputs the start control information to the arithmetic device 200.

With such processes, the control of the circuits can be simplified even when the holding circuit 101-2d holds a plurality of pieces of identification information always associated with the start condition information. In a case of a configuration in which a plurality of arithmetic devices 200 is provided, control of conditional determination is facilitated by holding the start condition information by each of the arithmetic devices 200.

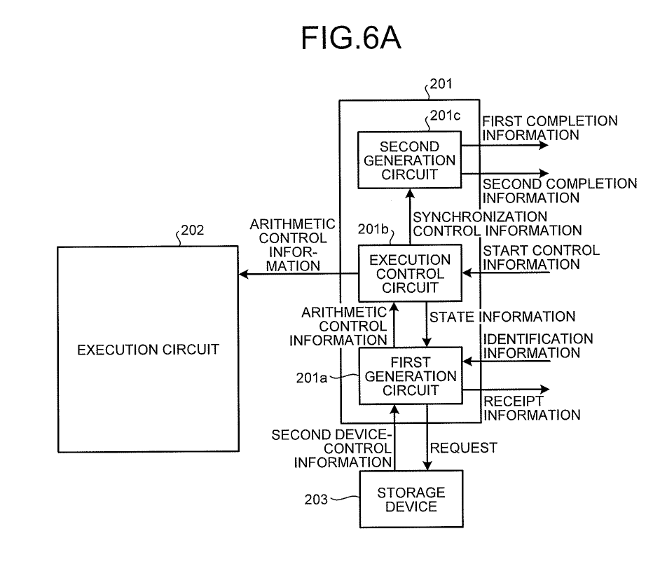

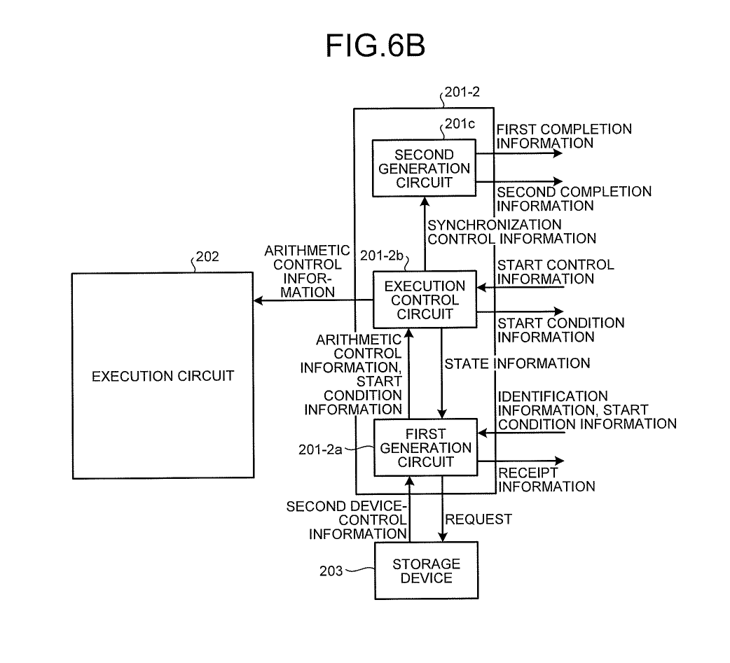

Next, more detailed configurations of the components of the arithmetic device 200 will be described. First, a detailed configuration of the arithmetic control circuit 201 will be described. FIG. 6A is a block diagram illustrating an example of a more detailed configuration of the arithmetic control circuit 201 of the arithmetic device 200. As illustrated in FIG. 6A, the arithmetic control circuit 201 includes a first generation circuit 201a, an execution control circuit 201b, and a second generation circuit 201c. Note that FIG. 6A illustrates an exemplary configuration of the arithmetic control circuit 201 associated with the control device 100 of FIG. 5A.

The first generation circuit 201a generates arithmetic control information according to identification information input from the control device 100, and outputs the generated arithmetic control information to the execution control circuit 201b. When the identification information is input from the control device 100 while the first generation circuit 201a is in a state capable of receiving the identification information, the first generation circuit 201a outputs receipt information indicating that the identification information is received to the control device 100.

The method in which the first generation circuit 201a generates the arithmetic control information from the identification information varies depending on the structure of the identification information. For example, when the identification information is constituted by operations to be executed such as specific instructions, the first generation circuit 201a generates the identification information as the arithmetic control information without any change. When the identification information is an address pointer of the storage device 203, the first generation circuit 201a reads out second device-control information at an address in the storage device 203 corresponding to the address pointer, generates arithmetic control information containing instructions in the read second device-control information, and outputs the arithmetic control information to the execution control circuit 201b. When the identification information is represented by a numerical value or the like, the first generation circuit 201a uses a look-up table or the like associating the identification information with the arithmetic control information, for example, to generate the arithmetic control information associated with the identification information. In this case, the first generation circuit 201a may be configured to use a look-up table associating the identification information with the address pointer of the storage device 203.

The identification information may contain operations to be executed, first completion information and second completion information. In this case, the arithmetic device 200 does not include the storage device 203, outputs the arithmetic control information containing operations in the identification information input from the control device 100 to the execution circuit 202, and outputs the first completion information or the second completion information to the control device 100.

The arithmetic control information contains information necessary for control of the arithmetic device 200 in addition to instructions to be executed by the execution circuit 202. For example, the arithmetic control information may contain information indicating completion of an arithmetic processing indicated by the identification information. Alternatively, the arithmetic control information may contain information (hereinafter referred to as synchronization control information) for synchronization with the control device 100 and other arithmetic devices 200. The first completion information and the second completion information described above, for example, correspond to the synchronization control information. When an arithmetic processing is constituted by a plurality of instructions, one piece of synchronization control information may be provided for one arithmetic processing or one piece of synchronization control information may be provided for one instruction.

When identification information is input, the first generation circuit 201a requests from the storage device 203 second device-control information associated with a first operation contained in an arithmetic processing identified by the identification information. When the second device-control information is input from the storage device 203, the first generation circuit 201a generates arithmetic control information containing instructions in the second device-control information and outputs the generated arithmetic control information to the execution control circuit 201b.

The first generation circuit 201a receives state information representing a state of the execution control circuit 201b from the execution control circuit 201b. When the input state information indicates that a processing is currently being executed, the first generation circuit 201a continues to output a request for next second device-control information to the storage device 203.

The first generation circuit 201a may read out the second device-control information only when the state of the execution control circuit 201b becomes an executing state, but the initialization overhead at the time of starting execution can be reduced by reading out the second device-control information in advance when the state is not an executing state.

The execution control circuit 201b controls the operating state of the arithmetic device 200 on the basis of start control information input from the control device 100 and arithmetic control information input from the first generation circuit 201a, and outputs state information to the first generation circuit 201a.

The execution control circuit 201b updates the internal state thereof according to the start control information input from the control device 100. In the initial state, the execution control circuit 201b is in a halted state. When start control information indicating that execution can be started is input during the halted state, the execution control circuit 201b becomes an executable state. In the executable state, the execution control circuit 201b outputs the arithmetic control information input from the first generation circuit 201a to the execution circuit 202. In this manner, a series of operations can be continuously executed. When the arithmetic control information input from the first generation circuit 201a during the executable state contains information indicating that all the operations are completed, the execution control circuit 201b changes the internal state to a halted state and terminates the arithmetic processing.

When the arithmetic control information contains synchronization control information, the execution control circuit 201b outputs the synchronization control information to the second generation circuit 201c. When the execution control circuit 201b is in the executing state, the execution control circuit 201b outputs the synchronization control information contained in the arithmetic control information to the second generation circuit 201c. For example, when the synchronization control information is the first completion information, the second generation circuit 201c outputs the first completion information as information for determining whether the control device 100 can start execution of a decision process for a next processing. When the synchronization control information is the second completion information, the second generation circuit 201c outputs the second completion information as information for determining whether the control device 100 can start execution of a next processing.

Next, another exemplary configuration of the arithmetic control circuit 201 will be described. FIG. 6B is a block diagram illustrating an example of a detailed configuration of an arithmetic control circuit 201-2 according to another exemplary configuration. FIG. 6B illustrates an exemplary configuration of the arithmetic control circuit 201-2 associated with the control unit 100 of FIG. 5B.

As illustrated in FIG. 6B, start condition information is input together with identification information to a first generation circuit 201-2a and the first generation circuit 201-2a outputs the start condition information to an execution control circuit 201-2b according to this exemplary configuration. The execution control circuit 201-2b outputs the start condition information to the control device 100 and changes the state thereof depending on whether the input of the start control information is true or false.

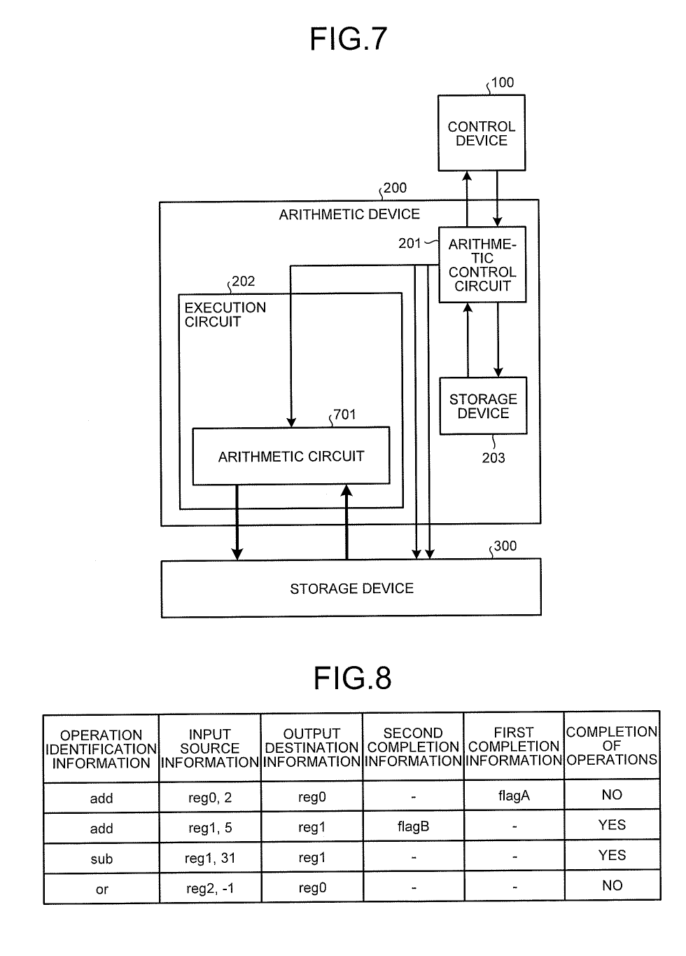

Next, a more detailed configuration of the execution circuit 202 of the arithmetic device 200 will be described with reference to FIGS. 7 to 14. FIG. 7 is a block diagram illustrating an example of a more detailed configuration of the execution circuit 202 of the arithmetic device 200. As illustrated in FIG. 7, the execution circuit 202 includes an arithmetic circuit 701.

As described above, the execution circuit 202 receives the arithmetic control information as input from the arithmetic control circuit 201 and executes operations. The arithmetic control information contains operation identification information identifying an operation to be executed, input source information containing a source from which input data are read and a constant value to be used for an operation, and output destination information containing a destination into which an operation result is to be written, for example. The specific data structure of the arithmetic control information varies depending on the configuration of the execution circuit 202.

With the configuration illustrated in FIG. 7, the execution circuit 202 is constituted by a single arithmetic circuit 701. The arithmetic circuit 701 receives data and instructions as input, and executes operation on the input data according to the input instructions. The arithmetic circuit 701 may be constituted by a single computing unit such as an arithmetic logic unit (ALU), or may have a single instruction, multiple data (SIMD) architecture in which a plurality of computing units are provided and the same instructions are input to all of the computing units. Alternatively, the arithmetic circuit 701 may include a plurality of computing units and have a multiple instruction, multiple data (MIMD) architecture in which different instructions can be input to different computing units. Still alternatively, the arithmetic circuit 701 may have combinations of computing units having such architectures.

With the exemplary configuration of FIG. 7, a single instruction for the arithmetic circuit 701 may be used as the operation identification information. FIG. 8 is a table illustrating an example of the arithmetic control information used in the configuration of FIG. 7. As illustrated in FIG. 8, when the arithmetic circuit 701 is constituted by a single computing unit, the arithmetic control information may contain an instruction (operation identification information), input source information, and output destination information. For example, the arithmetic control information on the first line in FIG. 8 represents reading out input data from reg0, adding a constant value of 2 thereto, and writing the result into reg0. In a case of a configuration in which a plurality of computing units is provided, the arithmetic control information may contain a plurality of instructions, a plurality of pieces of input source information and a plurality of pieces of output destination information.

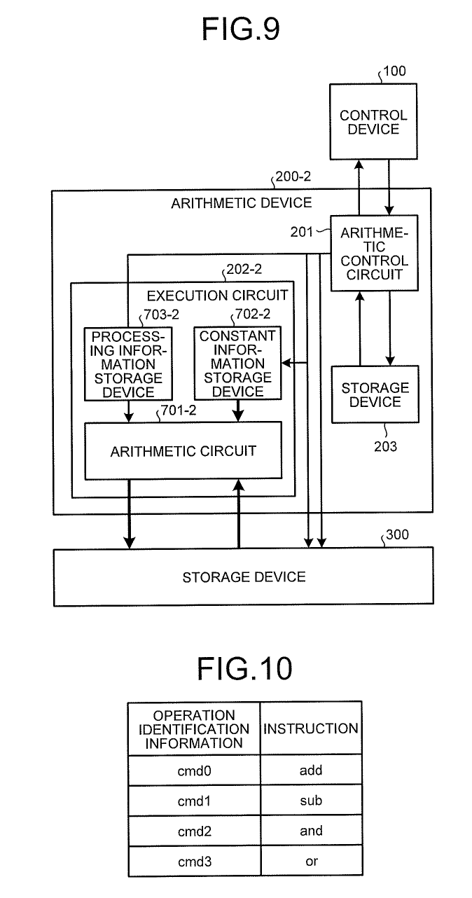

FIG. 9 is a block diagram illustrating an example of a detailed configuration of an arithmetic device 200-2 including an execution circuit 202-2 having a configuration different from that of FIG. 7. As illustrated in FIG. 9, the execution circuit 202-2 includes an arithmetic circuit 701-2, a constant information storage device 702-2, and a processing information storage device 703-2.

The processing information storage device 703-2 receives operation identification information as input and outputs an instruction associated with the operation identification information. FIG. 10 is a table illustrating an example of a data structure of processing information stored in the processing information storage device 703-2. As illustrated in FIG. 10, the processing information storage device 703-2 stores processing information associating operation identification information (such as cmd0) represented by a symbol and a numerical value with an instruction instead of an instruction itself.

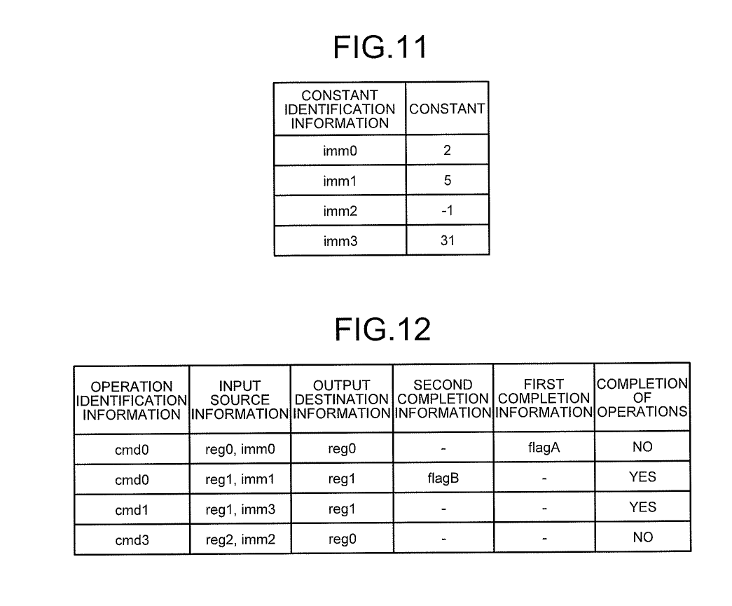

The constant information storage device 702-2 receives constant identification information identifying a constant value to be used in an operation as input and outputs a constant value associated with the constant identification information. FIG. 11 is table illustrating an example of a data structure of constant information stored in the constant information storage device 702-2. As illustrated in FIG. 11, the constant information storage device 702-2 stores constant information associating constant identification information with a constant.

The arithmetic circuit 701-2 executes an operation using an instruction input from the processing information storage device 703-2, a constant value input from the constant information storage device 702-2, and input data input from the storage device 300, and outputs the operation result to the storage device 300.

FIG. 12 is a table illustrating an example of the arithmetic control information used in the configuration of FIG. 9. In such a case as in the example of FIG. 9, the arithmetic control information may contain operation identification information contained in processing information from the processing information storage device 703-2 and constant identification information contained in constant information from the constant information storage device 702-2 as illustrated in FIG. 12. FIG. 12 illustrates an example in which the constant identification information (such as imm0) is contained in the input source information.

Although the processing information storage device 703-2 and the constant information storage device 702-2 are separately provided in the example of FIG. 9, either one of the storage devices may be provided or the storage devices may be provided as a single storage device. In a case where only the processing information storage device 703-2 is provided, the arithmetic control information may contain information representing a constant value necessary for an operation instead of the constant identification information. In a case where only the constant information storage device 702-2 is provided, on the other hand, the arithmetic control information may contain an instruction itself necessary of an operation instead of the operation identification information represented by a symbol, a numerical value and the like.

If all the instructions are held in the operation identification information as in the example of FIG. 7 in a case where the arithmetic circuit 701-2 has a MIMD architecture in which different instructions can be input to a number of different computing units, a large amount of memory is required for the storage device 203. Therefore, instructions and constants are held in the processing information storage device 703-2 and the constant information storage device 702-2, respectively, and only identification information thereof is held in the storage device 203 as in the example of FIG. 9. In this manner, the same process can be realized with a smaller amount of information.

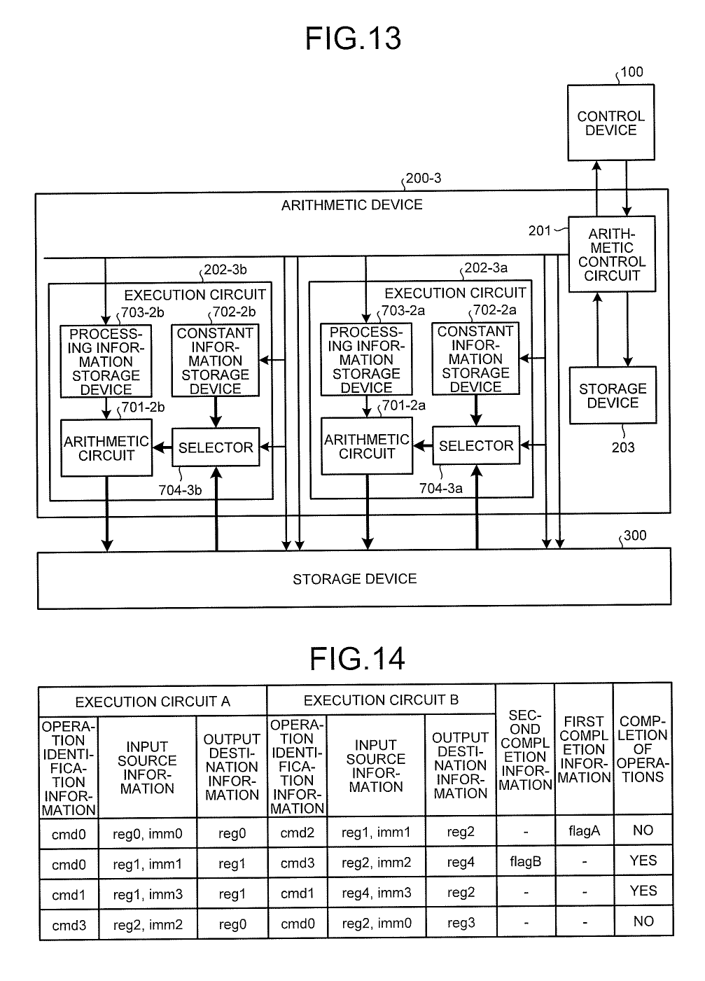

FIG. 13 is a block diagram illustrating an example of a detailed configuration of an arithmetic device 200-3 different from those of FIGS. 7 and 9. As illustrated in FIG. 13, the arithmetic device 200-3 includes two execution circuits 202-3a and 202-3b each additionally including a selector (selectors 704-3a, 704-3b) as compared to the execution circuit 202-2 of FIG. 9. The number of execution circuits 202-3 may be three or larger.

FIG. 14 is a table illustrating an example of the arithmetic control information used in the configuration of FIG. 13. In such a case as in the example of FIG. 13, the arithmetic control information may contain sets of operation identification information, input source information and output destination information, the number of the sets corresponding to the number of execution circuits 202-2 as illustrated in FIG. 14.

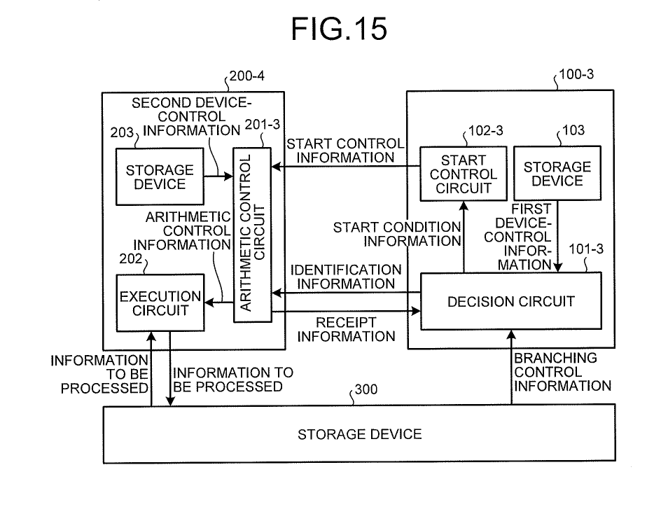

As described above, the processing start condition and the decision start condition do not need to be conditions of waiting for input of a specific interrupt signal but may be conditions of waiting for a statically determined value such as the number of cycles. A second modified example of the embodiment with such a configuration will be described below. FIG. 15 is a block diagram illustrating an example of the configuration of the semiconductor device 1 according to the second modified example of the embodiment.

In this modified example, the configuration is different from that of FIG. 2A in that output of first completion information from an arithmetic control circuit 201-3 of an arithmetic device 200-4 to a decision circuit 101-3 of a control device 100-3 and output of second completion information from the arithmetic control circuit 201-3 of the arithmetic device 200-4 to a start control circuit 102-3 of the control device 100-3 are not needed. Since the other components are similar to those in FIG. 2A, the components will be designated by the same reference numerals and the description thereof will not be repeated.

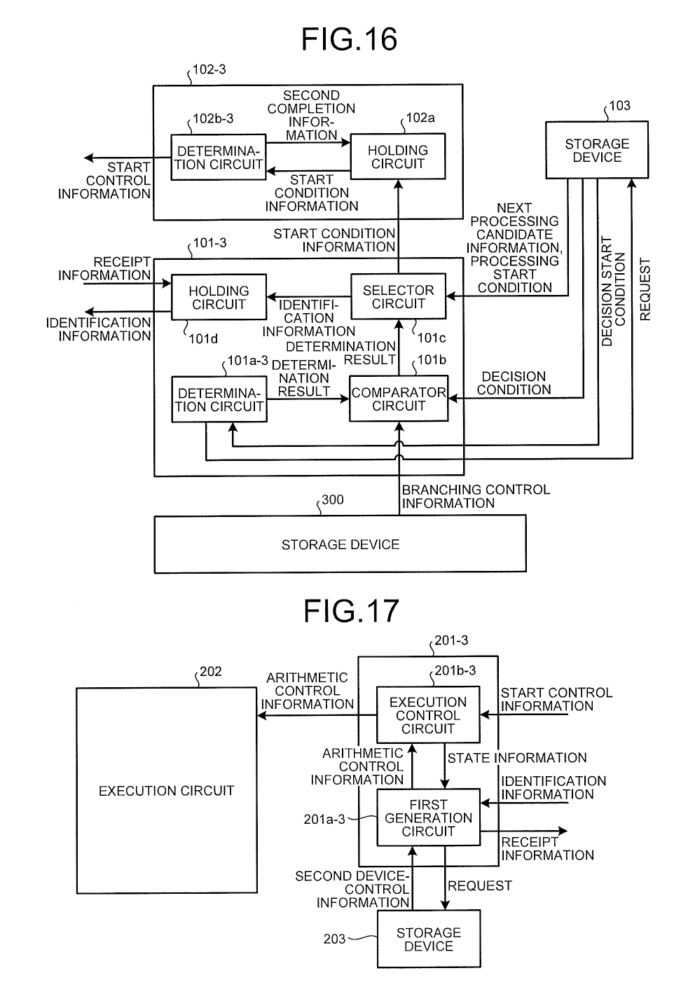

FIGS. 16 and 17 are more detailed block diagrams of the control device 100-3 and the arithmetic device 200-4, respectively of the second modified example of FIG. 15.

Since a determination circuit 101a-3 in the decision circuit 101 of the control device 100-3 has only to output a determination result indicating validity after receiving a processing start condition as input and waiting for a predetermined number of cycles, the structure thereof can be simplified. For example, the determination circuit 101a-3 can be realized by providing therein a counter (not illustrated) and a comparator (not illustrated) that compares a counter value of the number of cycles to be waited for. A determination circuit 102b-3 can similarly realized with a simple structure.

Furthermore, since the arithmetic control circuit 201-3 of the arithmetic device 200-4 does not need to output first completion information and second completion information, the second generation circuit 201c is not needed, and the control can thus be simplified.

When the processing start condition and the decision start condition are represented by values that can be statically determined as in this modified example, flexible control is difficult because separate control will be required for different relations between previous and next processings but the circuit can be simplified.

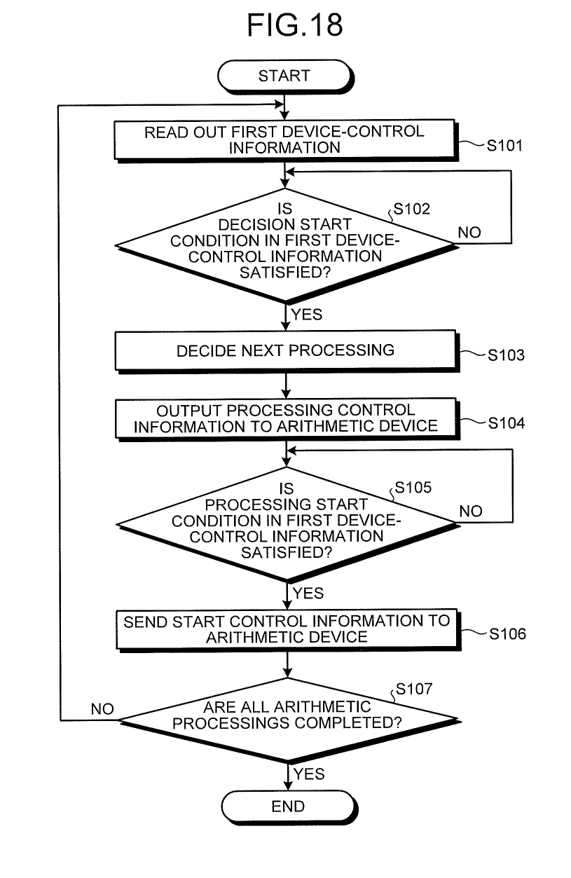

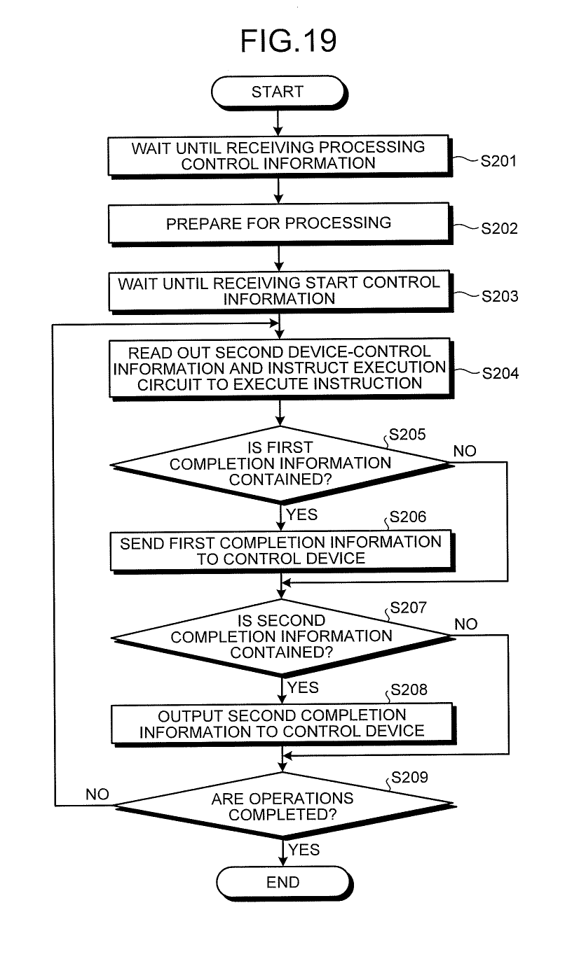

Next, operations of the control device 100 and the arithmetic device 200 of the semiconductor device 1 having such a configuration will be described with reference to FIGS. 18 and 19. FIG. 18 is a flowchart illustrating a flow of the entire operation of the control device in the embodiment.

First, the decision circuit 101 of the control device 100 reads out first device-control information from the storage device 103 (step S101). The address to be specified for reading the information out may be fixed or may be specified at the beginning of a process. Subsequently, the address for reading the first device-control information out from the storage device 103 may be sequentially incremented or may be specified in the first device-control information.

Next, the decision circuit 101 determines whether or not a decision start condition contained in the first device-control information is satisfied (step S102). If the decision start condition is not satisfied (No in step S102), the decision circuit 101 waits until the decision start condition is satisfied. If the decision start condition is satisfied (Yes in step S102), the decision circuit 101 executes a decision process for deciding a next processing (step S103).

As described above, the method for detecting a state in which execution of the decision process can be started (decision start condition) is contained in the first device-control information. If determination of a condition can be realized in a circuit, the decision start condition may be represented by the number of cycles to be waited for until execution of the decision process can be started or may be represented by input information indicating that the decision process becomes in an executable state that is input from the arithmetic device 200 or the storage device 300, for example.

The decision circuit 101 outputs processing control information containing identification information of the decided next processing to the arithmetic device 200 (step S104).

Next, the start control circuit 102 determines whether or not the processing start condition contained in the first device-control information is satisfied (step S105). If the processing start condition is not satisfied (No in step S105), the start control circuit 102 waits until the processing start condition is satisfied. If the processing start condition is satisfied (Yes in step S105), the start control circuit 102 outputs start control information indicating that execution of the next processing can be started to the arithmetic device 200 (step S106).

As described above, the processing start condition is contained in the first device-control information. If determination of a condition can be realized in a circuit, the processing start condition may be represented by the number of cycles until the arithmetic processing can be executed, for example. Alternatively, the processing start condition may be represented by input information indicating that the arithmetic processing becomes in an executable state that is input from the arithmetic device 200 or the storage device 300, or may be represented by an internal state of the control device 100. In this case, the internal state of the control device 100 may be changed according to a signal from the arithmetic device 200, the storage device 300 or outside.

Although the determination of the processing start condition (step S105) is executed after the decision process (step S103) in FIG. 18, these steps may be executed in reverse order or at the same time. Note that the start control information needs to be input to the arithmetic device 200 in association with the corresponding processing control information. For example, a method of setting a protocol limitation such as outputting the processing control information and the start control information at the same time, outputting the start control information after the processing control information or outputting the processing control information after the start control information. Alternatively, a method of associating corresponding processing control information and start control information by tagging may be used.

After outputting the start control information, the decision circuit 101 determines whether or not the first device-control information contains information indicating completion of the arithmetic processing (step S107). If the information indicating completion of the arithmetic processing is not contained (No in step S107), next first device-control information is read out (step S101), and subsequent processing is repeated. If the information indicating completion of the arithmetic processing is contained (Yes in step S107), the control device 100 terminates the operation.

FIG. 19 is a flowchart illustrating a flow of the entire operation of the arithmetic device 200 in the embodiment.

First, the arithmetic control circuit 201 of the arithmetic device 200 waits until processing control information is input from the control device 100 (step S201). When the processing control information is input, the arithmetic control circuit 201 performs preparation such as setting of configuration according to the processing control information (step S202), and waits until start control information is input (step S203). Although the preparation for a processing need not be executed, the overhead caused by setting of configuration when the start control information is input can be reduced by performing the preparation.

When the start control information is input, the arithmetic control circuit 201 reads out second device-control information from the storage device 203, and instructs the execution circuit 202 to execute an instruction contained in the second device-control information (step S204).

The arithmetic control circuit 201 determines whether or not first completion information is contained in the read second device-control information (step S205). If the first completion information is contained in the second device-control information (Yes in step S205), the arithmetic control circuit 201 outputs the first completion information to the control device 100 (step S206). The arithmetic control circuit 201 also determines whether or not second completion information is contained in the read second device-control information (step S207). If the second completion information is contained in the second device-control information (Yes in step S207), the arithmetic control circuit 201 outputs the second completion information to the control device 100 (step S208). The execution of operations (step S204), the output of the first completion information (step S206) and the output of the second completion information (step S208) do not have to be executed in the order illustrated in FIG. 19 but may be executed in any order or may be executed at the same time.

The arithmetic control circuit 201 determines whether or not information indicating completion of operations is contained in the arithmetic control information after execution of operations by the execution circuit 202 is completed (step S209). If the information indicating completion of operations is not contained (No in step S209), next second device-control information is read out (step S204) and subsequent processing is repeated. If the information indicating completion of operations is contained (Yes in step S209), the arithmetic device 200 terminates the operation.

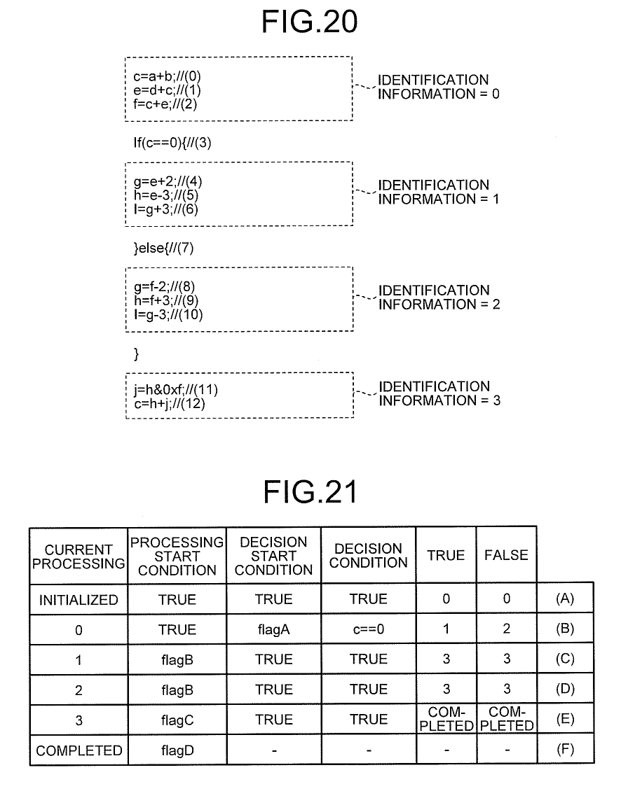

Next, a specific example of the operation of the semiconductor device 1 will be described with reference to FIGS. 20 to 25. FIG. 20 is a diagram illustrating an example of a program to be executed in this example.

The program illustrated in FIG. 20 is composed of four basic blocks. A basic block corresponds to a unit of processing containing one or more operations that can be executed sequentially without occurrence of any conditional branching, that is, an arithmetic processing described above. In the example of FIG. 20, a program including four basic blocks with identification information=0 to 3 is presented.

Conditional branching between the basic blocks with identification information=1 and 2 is executed according to Expression (3), and either one of the basic blocks is executed. Since data c are used in Expression (3), Expression (0) for calculating the data c needs to be completed so as to execute Expression (3). This dependency will be hereinafter referred to as dependency A.

Since the basic block with identification information=1 uses data c outside of the basic block for the operation, the operation cannot be started until Expression (1) that calculates the data e is completed. This dependency will be hereinafter referred to as dependency B. Similarly, the basic block with identification information=2 cannot start the operation until Expression (2) that calculates data f is completed. This dependency will be hereinafter referred to as dependency C. The basic block with identification information=3 cannot execute the operation until Expression (5) or Expression (9) that calculate data h is completed. This dependency will be hereinafter referred to as dependency D.

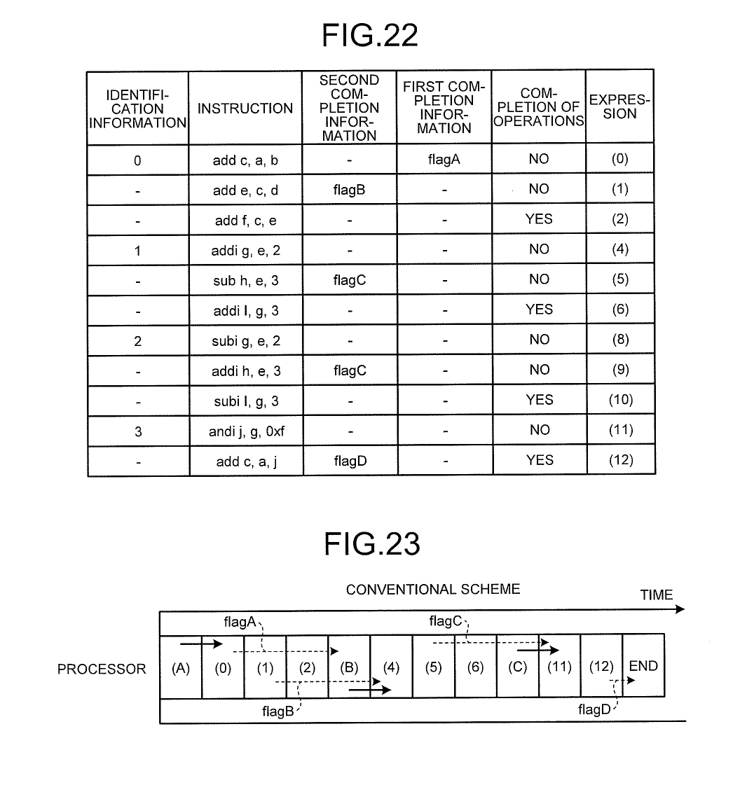

FIGS. 21 and 22 are tables representing first device-control information and second device-control information for executing the program of FIG. 20.

The dependencies of operations described above are resolved by using flags held in a flag register or the like. The dependency A is resolved by “flagA”. The dependencies B and C are resolved by “flagB”. The dependency D is resolved by “flagC”.

Symbols (A) to (F) shown in the right column of the table of FIG. 21 are to correspond to arithmetic processings that will be described with reference to FIGS. 23 to 25. Symbols (0) to (12) shown in the right column of the table of FIG. 22 represent that these correspond to Expressions (0) to (12) that are Expressions in FIG. 20. These symbols are shown for convenience sake, and the first device-control information and the second device-control information need not contain these symbols.

FIGS. 23, 24 and 25 are timing chart in a case where the program of FIG. 20 is processed by a conventional general-purpose processor, in a case where the program of FIG. 20 is processed by the semiconductor device 1 (FIG. 1A) including one arithmetic device 200, and in a case where the program of FIG. 20 is processed by the semiconductor device 1-2 (FIG. 1B) including two arithmetic devices 200, respectively.

When the program is processed by the conventional general-purpose processor, branching operations and other arithmetic processings all need to be executed by the same processor as illustrated in FIG. 23, which cannot achieve parallelism and thus results in a long execution time

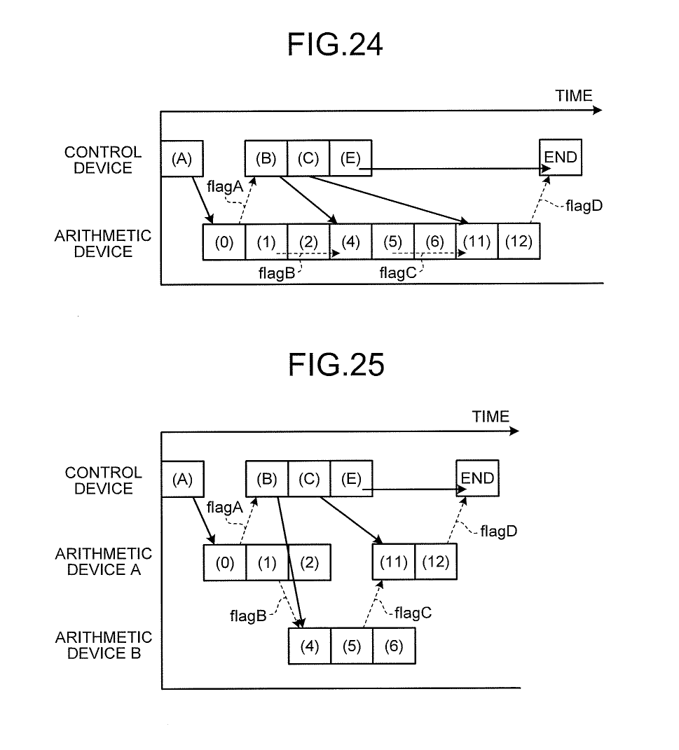

When the program is processed by the semiconductor device 1 including one arithmetic device 200, branching operations and arithmetic processings can be executed in parallel as illustrated in FIG. 24. As a result, the cost required for conditional branching can be reduced and processeings can be executed at a higher speed than the conventional processor.

Since Expression (0) executed by the arithmetic device 200 needs to be completed (flagA of the decision start condition) for performing conditional determination of the arithmetic processing (B), the control device 100 waits until the operation (0) of the arithmetic device 200 is completed after completing the arithmetic processing (A). Furthermore, since the decision start conditions of the arithmetic processing (C) and the arithmetic processing (E) are true, a next arithmetic processing can be determined without waiting for another arithmetic processing.

Since only one arithmetic device 200 is present, the processing start conditions (inputs of flagB and flagC, respectively) are satisfied at the time of starting arithmetic processings even when flags are specified by the processing start conditions of the arithmetic processings like the arithmetic processings with identification information=1 and 3. The arithmetic processings can therefore be executed immediately.

When two arithmetic devices 200a and 200b are provided as in FIG. 1B, arithmetic processings can also be executed in parallel between the arithmetic device 200a and the arithmetic device 200b in addition to parallel execution of branching processes and arithmetic processings as illustrated in FIG. 25. As a result, the execution time can be further shortened. In the example of FIG. 25, the arithmetic processing with identification information=0 (Expressions (0), (1) and (2)) and the arithmetic processing with identification information=3 (Expressions (11) and (12)) by the arithmetic device 200a and the arithmetic processing with identification number=1 (Expressions (4), (5) and (6)) by the arithmetic device 200b can be executed in parallel.

Since the processing start condition for the arithmetic processing with identification information=1 is flagB, the arithmetic device 200b waits without starting execution of the arithmetic processing with identification information=1 until the arithmetic device 200a completes Expression (1). Similarly, since the processing start condition for the arithmetic processing with identification information=3 is flagC, the arithmetic device 200a waits without starting execution of the process with identification information=3 until the arithmetic device 200b completes Expression (5).

Since the arithmetic processings can be executed in parallel after resolving the dependencies as described above, the execution time can be shortened by executing processes such as Expression (2) and Expression (4) or Expression (6) and Expression (11) in parallel by a plurality of arithmetic devices 200a and 200b.

Next, a method of allocating arithmetic processings to arithmetic devices 200a and 200b when the plurality of arithmetic devices 200a and 200b is provided as in FIG. 2A will be described. First, a method of allocation by static control using software will be described.

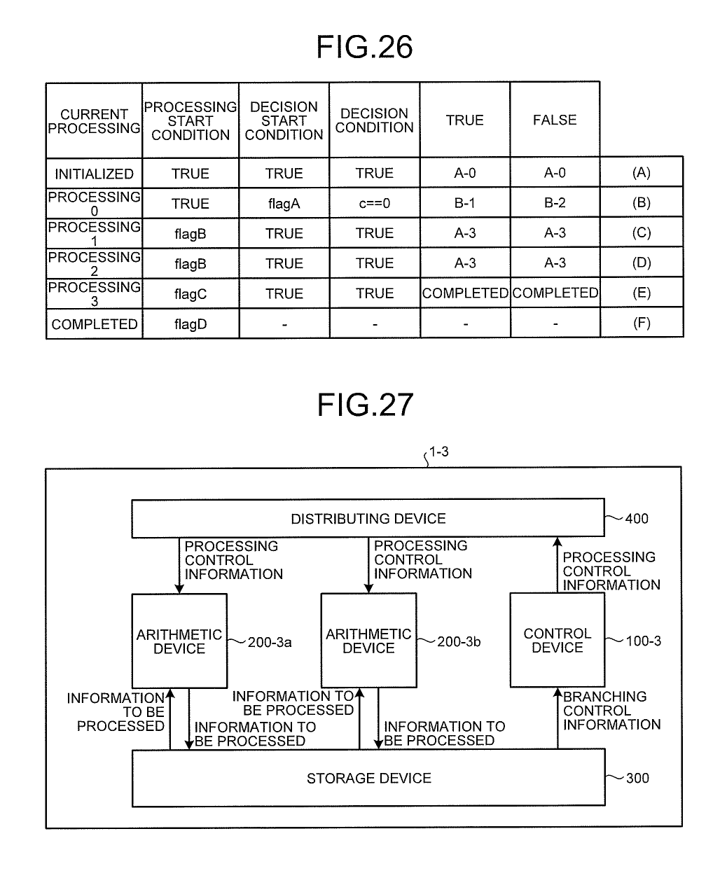

In this case, an identifier of an arithmetic device 200 that will execute a next processing is added to identification information of each of next processings specified by next processing identification information in first device-control information, for example. As a result, an arithmetic device 200 that will execute an arithmetic processing can be explicitly specified for the arithmetic processing (next processing) to be executed. FIG. 26 is a table illustrating an example of first device-control information in a case where the program of FIG. 20 runs as illustrated in FIG. 25. The example of FIG. 26 illustrates that arithmetic processings with identification information=0 and 3 are executed by the arithmetic device 200a and arithmetic processings with identification information=1 and 2 are executed by the arithmetic device 200b. In the example of FIG. 26, identifiers of the arithmetic devices 200a and 200b are represented by “A” and “B”, respectively. Although FIG. 26 illustrates an example in which only processes of one arithmetic device 200 are determined at a time, processes of a plurality of arithmetic devices 200 may be determined at a time.

As described above, even different contents (first device-control information) of the storage device 103 between a plurality of arithmetic devices 200 can be processed by specifying an arithmetic device 200 that executes each arithmetic processing by the first device-control information.

Next, a method of allocation by dynamic control using hardware will be described. FIG. 27 is a block diagram of an exemplary configuration of a semiconductor device 1-3 in a case of allocation according to control by hardware. As illustrated in FIG. 27, the semiconductor device 1-3 includes the control device 100-3, arithmetic devices 200-3a and 200-3b, the storage device 300 and a distributing unit 400.

The control device 100-3 inputs processing control information to the distributing unit 400. When the processing control, information is input, the distributing unit 400 selects a suitable arithmetic device 200 according to predetermined criteria depending on the operating state of the arithmetic devices 200, and outputs the processing control information to the selected arithmetic device 200. For example, the distributing unit 400 uses a criterion that the processing control information is to be output to an arithmetic device 200 with a smaller load. In this case, the distributing unit 400 determines whether the arithmetic devices 200 are in an executing state or in a halted state, and outputs the processing control information to an arithmetic device 200 being in the halted state.

In a case where the arithmetic devices 200 each hold a memory for storing processing control information, the distributing unit 400 may use a criterion that the processing control information is to be output to an arithmetic device 200 with smaller amount of processing control information held in the memory. As, a result of preferentially allocating arithmetic processings to arithmetic devices 200 with smaller loads in this manner, more efficient load distribution can be realized and improvement in processing performance can be expected.

Alternatively, criteria other than loads may be used. For example, if arithmetic processings with high dependencies on data in operations are allocated to be executed by the same arithmetic device 200, the number of accesses to the memory can be reduced. Note that information necessary for allocation of arithmetic processings may be added to the processing control information as necessary.

As a result of performing such a dynamic allocation control, a process can be executed by an optimum arithmetic device 200 depending on the load thereof. Since arithmetic processings are dynamically issued to all the arithmetic devices 200, the arithmetic devices 200 need to hold the same arithmetic control information. Thus, the contents of the storage devices 103 in the arithmetic devices 200 need to be made consistent. In this case, if the storage devices 103 are shared using a multi-port memory and a hierarchical cache structure, the same arithmetic control information can be held with a smaller amount of hardware resources. In a case where performance degradation can be permitted, a shared memory may be used for the storage devices 103 and arbitration is executed when there are accesses from a plurality of arithmetic devices 200, which allows the arithmetic control information to be shared with a smaller amount of resources.

As described above, the semiconductor device 1 according to the embodiment includes an arithmetic device and a control device. When information necessary for determination on conditional branching is obtained as a result of an operation contained in an arithmetic processing being executed, the arithmetic device outputs the information to the control device. The control device refers to the information to perform conditional branching control. As a result, branching operations by the control device and arithmetic processings by the arithmetic device can be executed in parallel. It is thus possible to more efficiently execute processes including branching processes.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor device comprising:
an arithmetic device configured to execute a plurality of arithmetic processings containing one or more operations; and
a control device configured to control the arithmetic device, wherein
the arithmetic device includes a first storage unit configured to store therein first device-control information for deciding a next arithmetic processing and a timing at which the next arithmetic processing is executed, the next arithmetic processing being an arithmetic processing to be executed next to an arithmetic processing currently being executed by the arithmetic device, the arithmetic device includes a second storage unit configured to store therein second device-control information for deciding a content of an operation contained in an arithmetic processing,
the control device reads out the first device-control information from the first storage unit, and determines whether a decision start condition defined for each arithmetic processing is satisfied by using the first device-control information, the decision start condition being a condition on which the next arithmetic processing is decided,
the control device decides, when the decision start condition is satisfied, the next arithmetic processing, by using the first device-control information, and outputs identification information for identifying the next arithmetic processing to the arithmetic device,
the control device determines whether a processing start condition defined for each arithmetic processing is satisfied, the processing start condition being a condition on which the arithmetic processing to be executed next by the arithmetic device is executed, and instructs the arithmetic device to start the arithmetic processing when the processing start condition is satisfied, and
the arithmetic device reads out the second device-control information identified by the identification information from the second storage unit, decides a content of an operation contained in the arithmetic processing specified by the identification information, by using the second device-control information, and starts, when instructed to start the arithmetic processing by the control device, executing the content of the operation contained in the arithmetic processing specified by the identification information.

2. The device according to claim 1, wherein
when the arithmetic device has executed a predetermined first operation contained in a first arithmetic processing among the plurality of arithmetic processings, the arithmetic device outputs first completion information indicating that execution of the first operation is completed, and
the control device determines whether the first completion information is output on the basis of the decision start condition indicating whether the first completion information is output, and decides, when the first completion information is determined to be output, an arithmetic processing to be executed next to the first arithmetic processing and notifies the arithmetic device of the decided arithmetic processing.

3. The device according to claim 1, wherein
when the arithmetic device has executed a predetermined second operation contained in a predetermined second arithmetic processing among the plurality of arithmetic processings, the arithmetic device outputs second completion information indicating that execution of the second operation is completed, and
the control device determines whether the second completion information is output on the basis of the processing start condition indicating whether the second completion information is output, and instructs, when determining that the second completion information is output, the arithmetic device to start the arithmetic processing to be executed.

4. The device according to claim 1, further comprising another one or more arithmetic devices corresponding to the arithmetic device according to claim 1, respectively, wherein
the control device notifies any of the arithmetic devices of the arithmetic processing decided to be the arithmetic processing to be executed next to the arithmetic processing currently being executed.

5. The device according to claim 1, wherein
the arithmetic device further includes a queue for temporarily storing one or more pieces of identification information output from the control device, and
the arithmetic processing to be executed next to the arithmetic process currently being executed by the arithmetic device is an arithmetic processing to be executed after an arithmetic processing stored in the queue is executed by the arithmetic device.
